(19) United States
(12) Patent Application Publication
(10) Pub. No.: US 2024/0347972 A1
(43) Pub. Date: Oct. 17, 2024

(54) CONNECTOR FITTING STRUCTURE

(71) Applicant: Yazaki Corporation, Tokyo (JP)

(72) Inventors: Reona FUJITA, Makinohara-shi (JP); Masataka Nagayama, Makinohara-shi (JP)

(73) Assignee: Yazaki Corporation, Tokyo (JP)

(21) Appl. No.: 18/611,062

(22) Filed: Mar. 20, 2024

(30) Foreign Application Priority Data
Apr. 13, 2023 (JP) 2023-065655

(51) Int. Cl. H01R 13/639

(52) U.S. Cl. CPC H01R 13/639

(57) ABSTRACT

A connector fitting structure includes a male connector and a female connector configured to fit each other and a restriction member configured to be attached to the male connector and the female connector in a fitting state to restrict release of the fitting state. Each of an accommodation portion of the male connector and a flexible piece of the female connector is formed with through holes configured to overlap each other in the fitting state of the male connector and the female connector. The restriction member includes a lid portion configured to overlap an outer surface of the accommodation portion to cover the through hole, an insertion portion protruding from the lid portion and configured to be inserted into the through holes, and a claw portion protruding from a front end portion of the insertion portion and configured to engage with an edge portion of the through hole.

### TECHNICAL FIELD

The present invention relates to a fitting structure of a male connector and a female connector.

### BACKGROUND

Patent Document 1 discloses an example of a fitting structure for a male connector and a female connector. The housing of the female connector includes a housing body that accommodates a female terminal and a lock arm that maintains a fitting state with the housing of the male connector. The housing of the male connector includes an accommodation portion in a box shape that accommodates the housing body and the lock arm. The accommodation portion is provided with a lock-receiving portion to which the lock arm engages.

### RELATED ART

### Patent Document

Patent Document 1: JP 2022-105377 A

### SUMMARY OF THE INVENTION

### Problem to be Solved by the Invention

In the above-mentioned connector fitting structure, it is desired to increase the fitting retention force between the connectors, and there is a scope of improvement.

Accordingly, it is an object of the present invention to provide a connector fitting structure capable of enhancing the fitting retention force of the male connector and the female connector.

### Solution to Problem

According to an embodiment of the present invention, a connector fitting structure includes a male connector and a female connector configured to fit each other, and a restriction member configured to be attached to the male connector and the female connector in a fitting state to restrict release of the fitting state, wherein a housing of the male connector and a housing of the female connector are formed with respective through holes configured to overlap each other in the fitting state, the restriction member includes: a lid portion configured to cover one of the two through holes situated on an outer side, an insertion portion protruding from the lid portion and configured to be inserted into the two through holes, and a claw portion protruding from a front end portion of the insertion portion and configured to engage with an edge portion of one of the two through holes situated on an inner side.

### Advantageous Effects of the Invention

According to the present invention, the fitting retention force of the male connector and the female connector can be enhanced by the restriction member.

### BRIEF DESCRIPTION OF THE DRAWINGS

FIG. 1 is a perspective view illustrating a connector fitting structure according to an embodiment of the present invention.

FIG. 2 is an exploded view illustrating the connector fitting structure in FIG. 1.

FIG. 3 is a cross-sectional view taken along line A-A of FIG. 1.

FIG. 4 is a perspective view illustrating a restriction member of FIG. 2.

### DETAILED DESCRIPTION OF THE EXEMPLARY EMBODIMENT

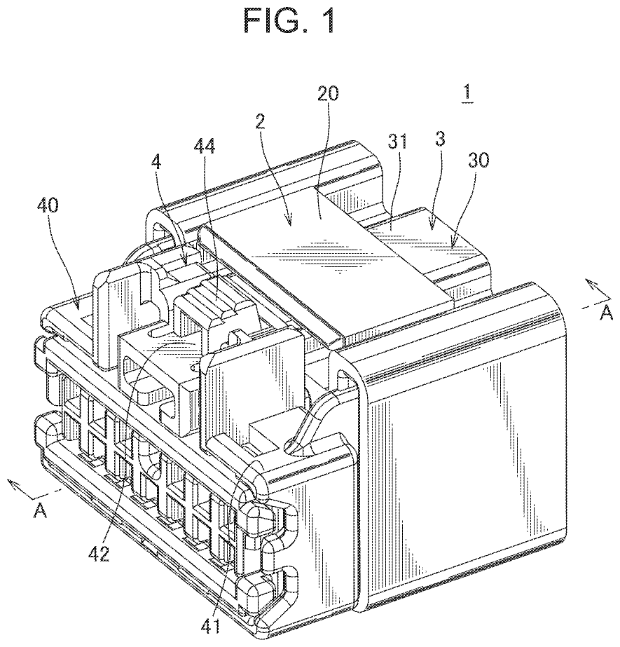

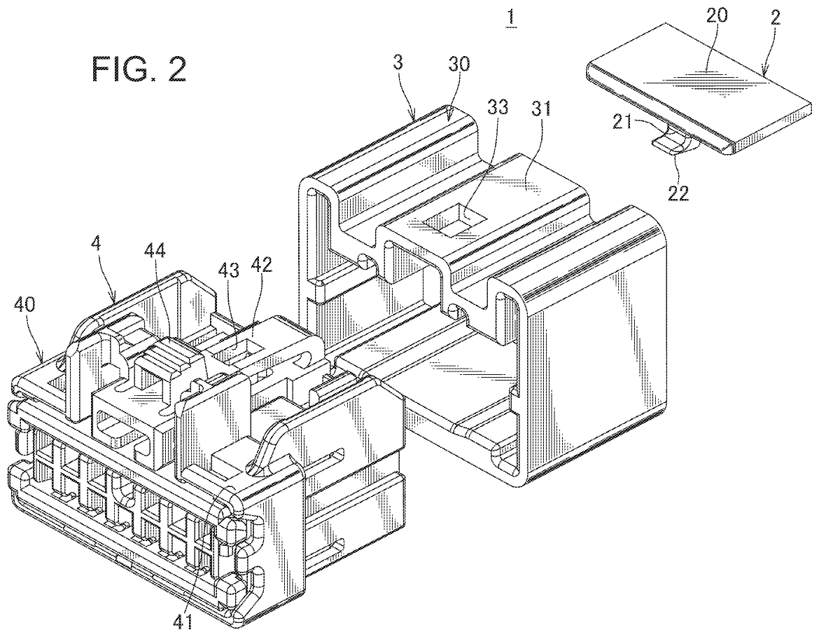

A connector fitting structure 1 according to an embodiment of the present invention will be explained with reference to FIGS. 1 to 4.

The connector fitting structure 1 illustrated in FIGS. 1 to 3 includes a male connector 3 and a female connector 4 configured to fit each other and a restriction member 2 configured to be attached to the male connector 3 and the female connector 4 in a fitting state to restrict release of the fitting state.

The female connector 4 includes a plurality of female terminals (not illustrated) and a housing 40 made of synthetic resin accommodating the plurality of female terminals. The housing 40 includes a housing body 41 that accommodates a plurality of female terminals, and a flexible piece 42 that is continuing to the outer surface of the housing body 41 and extends rearward in the fitting direction with an interval from the housing body 41.

In this specification, regarding the female connector 4, a side of the male connector 3 in the fitting direction with the male connector 3 is defined as a “front”, and a side away from the male connector 3 in the fitting direction is defined as a “rear”.

The male connector 3 includes a plurality of male terminals (not illustrated) and a housing 30 made of synthetic resin accommodating the plurality of male terminals. The housing 30 includes an accommodation portion 31 in a box shape that accommodates the housing body 41 and the flexible piece 42 of the female connector 4. The front end portions of the male terminals are situated within the accommodation portion 31.

In the fitted state, a rear half portion of the housing body 41 and a rear half portion of the flexible piece 42 are situated out of the accommodation portion 31. In addition, an operation portion 44 is provided on the rear half portion of the flexible piece 42, and when the operation portion 44 is pressed toward the housing body 41, the flexible piece 42 is bent toward the housing body 41.

The housing 30 of the male connector 3 and the housing 40 of the female connector 4 are formed with through holes 33, 43 that overlap each other in the fitting state. Specifically, the through holes 43, 33 are formed in the flexible piece 42 and the accommodation portion 31, respectively. From among the through holes 33, 43, the through hole 33 on the side of the accommodation portion 31 is situated on an outer side, and the through hole 43 on the side of the flexible piece 42 is situated on an inner side.

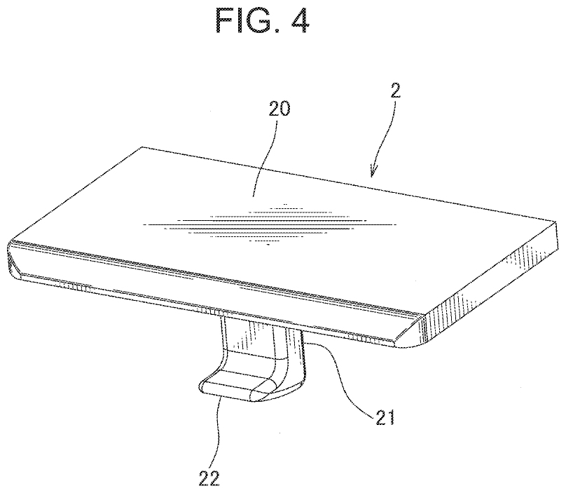

The restriction member 2 is made of synthetic resin. As illustrated in FIG. 4, the restriction member 2 includes a lid portion 20 in a rectangular plate shape, an insertion portion 21 in a plate shape protruding from one surface of the lid portion 20, and a claw portion 22 protruding from a front end portion of the insertion portion 21 in parallel to the lid portion 20.

The lid portion 20 overlaps the outer surface of the accommodation portion 31 to cover the through hole 33 to prevent foreign matters from entering the housings 30, 40 from the through holes 33, 43. For this reason, the lid portion 20 is formed larger than the through hole 33.

The insertion portion 21 is inserted into the through holes 33, 43 and comes into contact with the inner surfaces of the through holes 33, 43, thereby restricting the fitting state of the male connector 3 and the female connector 4 from being released (i.e., restricting the male connector 3 and the female connector 4 from moving in a direction away from each other).

The claw portion 22 restricts the insertion portion 21 from coming out of the through holes 33, 43 by engaging the edge portion of the through hole 43. The claw portion 22 allows the restriction member 2 to be held on the male connector 3 and female connector 4 without applying adhesive.

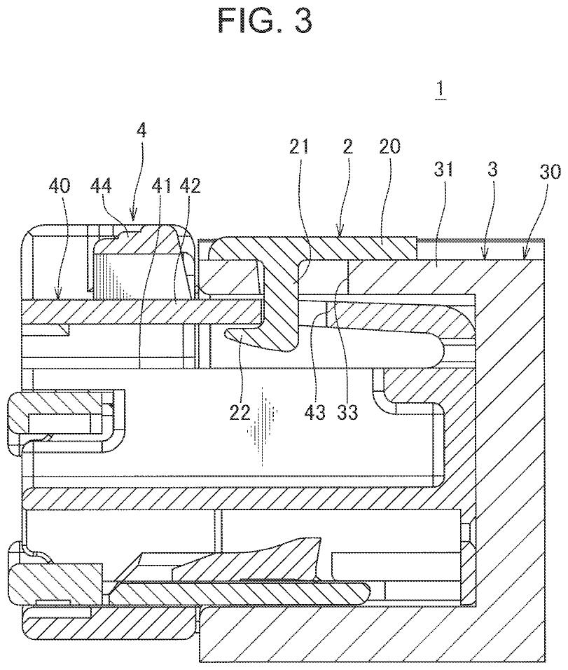

After the male connector 3 and female connector 4 are fitted, the restriction member 2 is press-fitted into the through holes 33, 43 to be attached to the male connector 3 and female connector 4. During press-fitting, the claw portion 22 is elastically deformed toward the lid portion 20, and the insertion portion 21 is elastically deformed toward a side opposite to the protruding direction of the claw portion 22. Then, as the claw portion 22 passes through the through hole 43, the elastic deformation of the claw portion 22 and the insertion portion 21 is restored, resulting in the state as illustrated in FIG. 3.

When the restriction member 2 is to be detached from the male connector 3 and the female connector 4, the claw portion 22 is disengaged from the edge portion of the through hole 43 by pressing the operation portion 44 and bending the flexible piece 42 toward the housing body 41, so that the lid portion 20 is lifted and removed. By removing restriction member 2 in this way, the fitting state of the male connector 3 and the female connector 4 can be released.

In this way, the connector fitting structure 1 can increase the fitting retention force of the male connector 3 and the female connector 4 with the restriction member 2. Moreover, foreign matter can be prevented from entering the housings 30, 40 through the through holes 33, 43.

Note that the above-described embodiment merely shows a typical form of the present invention, and the present invention is not limited to this embodiment. That is, various modifications can be made without departing from the gist of the invention. It is to be understood that such modifications are included within the scope of the present invention as long as they still have the configuration of the present invention.

### LIST OF REFERENCE SIGNS

1 connector fitting structure
2 restriction member
3 male connector
4 female connector
20 lid portion
21 insertion portion
22 claw portion
30, 40 housing
31 accommodation portion
33, 43 through hole
42 flexible piece 42

What is claimed is:

1. A connector fitting structure comprising:
a male connector and a female connector configured to fit each other; and
a restriction member configured to be attached to the male connector and the female connector in a fitting state to restrict release of the fitting state,
wherein a housing of the male connector and a housing of the female connector are formed with respective through holes configured to overlap each other in the fitting state,
the restriction member includes:
a lid portion configured to cover one of the two through holes situated on an outer side,
an insertion portion protruding from the lid portion and configured to be inserted into the two through holes, and
a claw portion protruding from a front-end portion of the insertion portion and configured to engage with an edge portion of one of the two through holes situated on an inner side.

2. The connector fitting structure according to claim 1, wherein the housing of the female connector includes:
a housing body configured to accommodate a female terminal; and
a flexible piece continuing to an outer surface of the housing body and extending rearward in a fitting direction with an interval from the housing body,
wherein the housing of the male connector includes an accommodation portion in a box shape that accommodates the housing body and the flexible piece,
the flexible piece and the accommodation portion are formed with the respective through holes, and
engagement of the claw portion to the edge portion is released by bending the flexible piece toward the housing body in a state in which the restriction member is attached to the male connector and the female connector.
